(19) United States
(12) Patent Application Publication
(10) Pub. No.: US 2026/0141287 A1
(43) Pub. Date: May 21, 2026

(54) UNIVERSAL R-SQUARED FOR ASESSING AND COMPARING MACHINE LEARNING MODELS THAT USE LINEAR OR NONLINEAR REGRESSION

(71) Applicant: INTERNATIONAL BUSINESS MACHINES CORPORATION, ARMONK, NY (US)

(72) Inventors: Abhay Choudhary, Dublin (IE); Jonathan David Dunne, Dungarvan (IE)

(21) Appl. No.: 18/950,634

(22) Filed: Nov. 18, 2024

(51) Int. Cl. G06N 20/00

(52) U.S. Cl. CPC G06N 20/00

(57) ABSTRACT

A method, computer program product, and computer system for assessing N machine learning models that predict a dependent variable. For n=1, . . . , N, a machine learning model n is trained using training data n comprising Iₙ data points, wherein data point Pₙᵢ in the training data n includes an observed dependent variable yₙᵢ (i=1, . . . , Iₙ), wherein the training includes: (i) tuning the machine learning model n to generate a predicted dependent variable f(xₙ)ₙᵢ that is fitted, using a regression algorithm n, to the observed dependent variable yₙᵢ (i=1, . . . , Iₙ), (ii) determining a universal R-squared (UR²ₙ) for the predicted dependent variables f(xₙ)ₙᵢ (i=1, . . . , Iₙ), and (iii) outputting f(xₙ)ₙᵢ (i=1, . . . , Iₙ) and UR²ₙ, wherein xₙ is a feature vector of features used by machine learning model n to predict the dependent variable f(xₙ)ₙᵢ (i=1, . . . , Iₙ).

### BACKGROUND

The present invention relates to comparing machine learning models, and more specifically, to assessing and comparing machine learning models that use linear or nonlinear regression.

### SUMMARY

Embodiments of the present invention provide a method, a computer program product, and a computer system, for assessing N machine learning (ML) models that predict a dependent variable, N being at least 1.

One or more processors of a computer system train a machine learning model n using training data n comprising Iₙ data points, wherein data point Pₙi in the training data n includes an observed dependent variable yₙᵢ (i=1, . . . , Iₙ).

Training the machine learning model n includes: (i) tuning the machine learning model n to generate a predicted dependent variable f(xₙ)ₙᵢ that is fitted, using a regression algorithm n, to the observed dependent variable yₙᵢ (i=1, . . . , Iₙ), (ii) determining a universal R-squared (UR²ₙ) for the predicted dependent variables f(xₙ)ₙᵢ (i=1, . . . , Iₙ), and (iii) outputting f(xₙ)ₙᵢ (i=1, . . . , Iₙ) and UR²ₙ, wherein xₙ is a feature vector of one or more features used by machine learning model n to predict the dependent variable f(xₙ)ₙᵢ (i=1, . . . , Iₙ).

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a flow chart describing a method for assessing N machine learning (ML) models that predict a dependent variable, N being at least 1, in accordance with embodiments of the present invention.

FIG. 3 is a flow chart describing alternative embodiments for determining a universal R-squared (UR²ₙ), in accordance with embodiments of the present invention.

FIG. 4 is a flow chart describing alternative embodiments for determining a best machine learning (ML) model, in accordance with embodiments of the present invention.

FIG. 5 illustrates a computer system, in accordance with embodiments of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

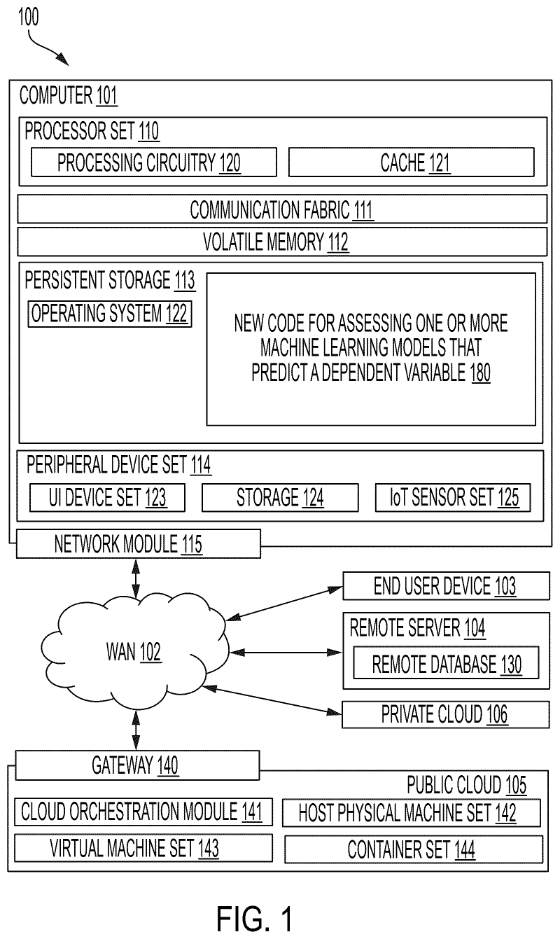

FIG. 1 depicts a computing environment 100 which contains an example of an environment for the execution of at least some of the computer code involved in performing the inventive methods, in accordance with embodiments of the present invention. Such computer code includes new code for assessing one or more machine learning models that predict a dependent variable 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Conventional methods for finding the quality of a linear regression model in nonlinear data (e.g., highly skewed data, cyclic data, etc.) for predicting a dependent variable (e.g., predicting resource usage data), use a R-squared method that outputs a score between 0 and 1 which is then used to compare two or more models to select the best model from the two or more models.

In a numerical dataset (continuous or discreet), where the relationship between the response variables and the predictor variables is nonlinear, the assumptions underlying the calculation of R-squared are not met so that R-squared is not a valid measure of goodness of fit.

Thus, conventional methods rely on multiple other non-absolute methods such as mean squared error (MSE), mean absolute error (MAE), root mean squared error (RMSE), Akaike's information criterion (AIC), Bayesian information criterion (BIC), etc. However, the preceding non-absolute methods cannot be used to compare different models since the values do not provide an absolute measure of goodness of fit (i.e., have a scale between 0-1) which makes it challenging to compare and select the best model.

There is no conventional solution that calculates an accurate goodness of fit value between 0-1 for data that is non-linear in nature, so the only available approach conventionally is to still use R-squared even though it is widely known that R-squared should not be used for non-linear data.

Thus, the R-squared approach can calculate an accurate model goodness only for linear data, requires models to follow all the principles of linear regression, and requires outlier removal and a data transformation to transform non-linear data to linear data. For some data, removal of outliers can degrade the data because the outliers may represent valid data. Further, removing outliers and implementing data transformation to convert non-linear data to a linear form is a big hassle and is never perfect.

For some datasets, segmented linear regression is an alternative conventional approach (for non-linear data) that segments model nonlinear data piecewise into data segments and applies multiple models to respective segments, calculates R-squared for each segment, and computes the average R-squared over all of the segments. However, all of the rules of linear regression must be followed which often leads to outlier removal and a data transformation to transform non-linear data to linear data. Thus, segmented linear regression has gaps, is not feasible for all types of data, is computationally very expensive, and still must be within the realms of linear regression.

Embodiments of the present invention provide a universal R-squared (UR²) score that uses a non-obvious combination of variances to find a model quality score for linear data or nonlinear data. Using the universal R-squared score does not require a data transformation that linearizes nonlinear data and does not require removal of outliers. The universal R-squared score also includes an impact of test data and/or training data on a learning model's overall quality. With universal R-squared, there is no need to use multiple non-absolute methods such as MSE, MAE, RMSE, etc. to compare different machine learning models. Universal R-squared is a quick and easy approach that can be used in existing machine learning model libraries.

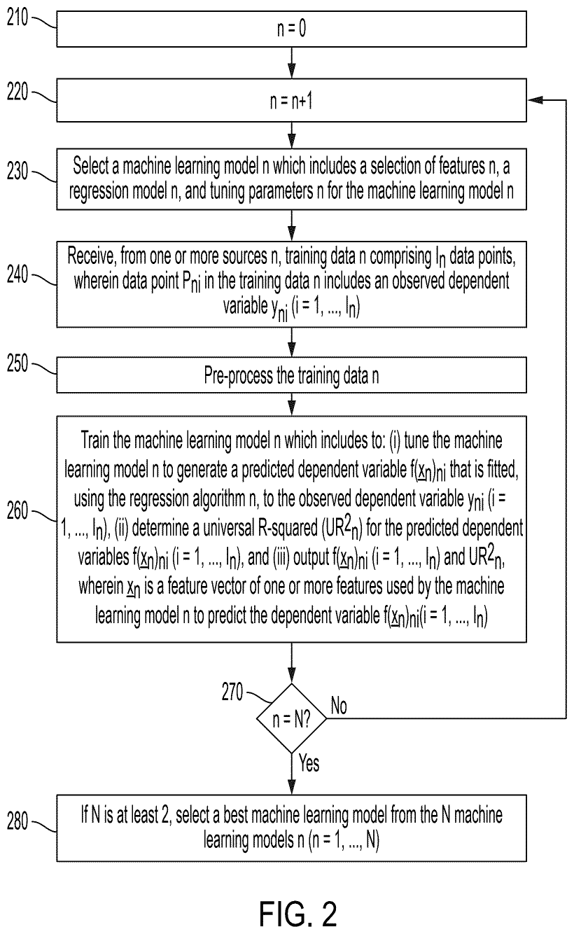

FIG. 2 is a flow chart describing a method for assessing N machine learning (ML) models that predict a dependent variable, N being at least 1, in accordance with embodiments of the present invention. The method of FIG. 1 includes steps 210-280.

Step 210 initializes an index n to zero. The index n indexes the machine learning models.

Step 220 increments n by 1.

Step 230 selects a machine learning model n capable of performing regression to predict a dependent variable and fit the predicted dependent variable to observed values of the dependent variable.

Step 240 selects for machine learning model n: features n, a regression model n, and tuning parameters n.

Features are measurable properties or characteristics of the training data used by the machine learning model for training and prediction, and are inputs that the machine learning model uses to learn patterns or make decisions. For example, in a machine learning model that predicts house prices, features could include square footage, number of rooms, location, and age of the house. Each feature represents a specific aspect of the input data that might influence the price.

One or more feature selection algorithms may be used for selecting the features, which provide advantages of helping the machine learning model to focus on the most meaningful data which reduces the machine learning model's complexity, eliminates irrelevant information, reduces storage and computation time, etc. If more than one feature selection algorithm is used, then a voting procedure or algorithm may be employed to select a top K features of the totality of features selected by the more than one feature selection algorithms. Examples of feature selection algorithms that may be used include, inter alia, XGBRegessor, random forests, Lasso regression, ridge regression, stepwise regression etc.

Regression algorithms that may be selected include, inter alia, a linear regression algorithm or a non-linear regression selected from, inter alia, polynomial regression, elastic net regression, random forest regression, gradient boosting regression, etc.

In one embodiment, the regression algorithm n is a non-linear regression algorithm.

In one embodiment, the regression algorithm n is a linear regression algorithm.

Tuning parameters control how the machine learning model learns from the training data and impacts model complexity and speed, and helps to optimize performance of the machine learning model. For example, in a machine learning neural network, tuning parameters may include, inter alia, number of layers, number of neurons per layer, batch size, etc. In a random forest, tuning parameters may include, inter alia, the number of trees and the maximum depth of each tree.

Step 240 receives, from one or more sources n, training data n comprising Iₙ data points, wherein data point Pₙᵢ in the training data n includes an observed dependent variable yₙᵢ (i=1, . . . , Iₙ). The number of data points (Iₙ) may differ in the different machine learning models n (n=1, . . . , N).

In one embodiment, the training data n includes at least one outlier in the observed dependent variables yₙᵢ (i=1, . . . Iₙ).

Step 250 pre-processes the training data n, which may include, inter alia, filling in data for missing data points in the training data received in step 240; e.g., by interpolation.

Step 260 trains the machine learning model n which includes: (i) tuning the machine learning model n to generate a predicted dependent variable f(xₙ)ₙᵢ that is fitted, using the regression algorithm n, to the observed dependent variable yₙᵢ (i=1, . . . , Iₙ), (ii) determining a universal R-squared (UR²ₙ) for the predicted dependent variables f(xₙ)ₙᵢ (i=1, . . . , Iₙ), and (iii) outputting f(xₙ)ₙᵢ (i=1, . . . , Iₙ) and UR²ₙ, wherein xₙ is a feature vector of one or more features used by the machine learning model n to predict the dependent variable f(xₙ)ₙᵢ (i=1, . . . , Iₙ).

Tuning the machine learning model n includes adjusting the values of the tuning parameters.

Universal R-squared (UR²) is defined by Equations (1)-(4).

$${UR}^{2} = \sqrt{PSS / ( P S S + RSS ) \times TSS / ( TSS + RSS )} \qquad ( 1 )$$

$$PSS = {\sum }_{i = 1}^{I} {( {f}_{i} - {f}_{a v e} )}^{2} \qquad ( 2 )$$

$$TSS = {\sum }_{i = 1}^{I} {( {y}_{i} - {y}_{a v e} )}^{2} \qquad ( 3 )$$

$$RSS = {\sum }_{i = 1}^{I} {( {y}_{i} - {f}_{i} )}^{2} \qquad ( 4 )$$

In Equations (1)-(4), there are I data points, yᵢ is the observed value of the dependent variable at data point i, fᵢ is the predicted value of the dependent variable at data point i, yₐᵥₑ is the arithmetic average of yᵢ over the I data points, and fₐᵥₑ is the arithmetic average of fᵢ over the I data points

UR², which is in a range of 0 to 1, is a measure of goodness of fit of the predicted values fᵢ to the observed values yᵢ (i=1, . . . , I). If UR²=1 then the fit is perfect. If UR²=0 then there is no fit.

From another point of view, UR² is a measure of the fraction of the variation in the observed dependent variable yᵢ that is accounted for by the variation in the predicted dependent variable fᵢ (i=1, . . . , I).

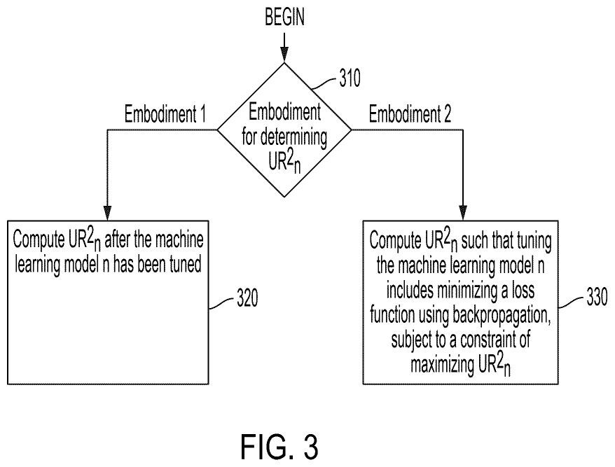

Alternative embodiments for determining a universal R-squared (UR²ₙ) are discussed infra in conjunction with FIG. 3.

Step 270 determines whether n=N. If so (Yes branch from step 270) then step 280 is next executed and if not (No branch from step 270) then processing loops back to step 220 to process the next machine learning model n+1.

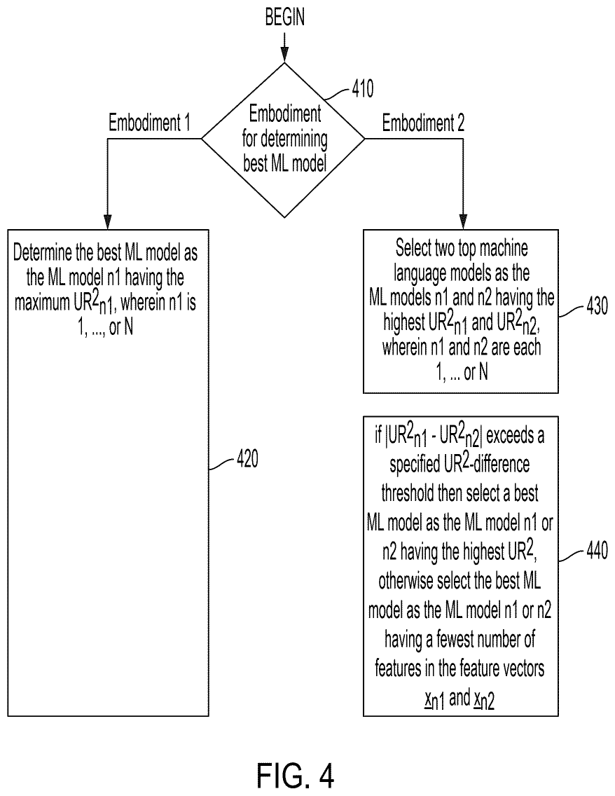

Step 280 selects, if N is at least 2, a best machine learning model from the N machine learning models. Alternative embodiments for selecting the best machine learning model are discussed infra in conjunction with FIG. 4.

FIG. 3 is a flow chart describing alternative embodiments for determining a universal R-squared (UR²ₙ), in accordance with embodiments of the present invention. The flow chart of FIG. 3 includes steps 310-330.

Step 310, which selects embodiment 1 or embodiment 2 for determining UR²ₙ, implements determining UR²ₙ in step 260 of FIG. 2.

If step 310 selects embodiment 1 or embodiment 2 then step 320 or step 330, respectively, is next executed.

For embodiment 1, step 320 computes UR²ₙ via Equations (1)-(4) after the machine learning model n has been tuned.

For embodiment 2, step 330 computes UR²ₙ, via Equations (1)-(4) such that tuning the machine learning model n includes minimizing a loss function using backpropagation, subject to a constraint of maximizing UR²ₙ.

FIG. 4 is a flow chart describing alternative embodiments for determining a best machine learning (ML) model, in accordance with embodiments of the present invention. The flow chart of FIG. 4 includes steps 410-440.

Step 410, which selects embodiment 1 or embodiment 2 for determining the best ML model, implements step 280 of FIG. 2.

If step determines that embodiment 1 or embodiment 2 should be used for determining the best ML model, then step 420 or steps 430-440, respectively, is next executed.

For embodiment 1, step 420 selects the best machine learning model as the machine learning model n1 having the maximum UR²ₙ₁, wherein n1 is 1, . . . or N.

For embodiment 2, steps 430 and 440 are executed.

Step 430 selects two top machine learning models as the machine learning models n1 and n2 having the highest UR²ₙ₁ and UR²ₙ₂, wherein n1 and n2 are each 1, . . . or N.

If |UR²ₙ₁−UR²ₙ₂| exceeds a specified UR²-difference threshold then step 440 selects, the best machine learning model as the machine learning model; otherwise step 440 selects the best machine learning model as the machine learning model n1 or n2 having a fewest number of features in the feature vectors xₙ₁ and xₙ₂.

In one embodiment, the training data n includes at least one outlier in the observed dependent variables yₙᵢ (i=1, . . . Iₙ).

In one embodiment, the regression algorithm n is a non-linear regression algorithm.

In one embodiment, N is at least 2, and the N machine learning models are selected from the group consisting of machine learning models having different regression algorithms, machine learning models having different features, machine learning models having different tuning parameters, and combinations thereof.

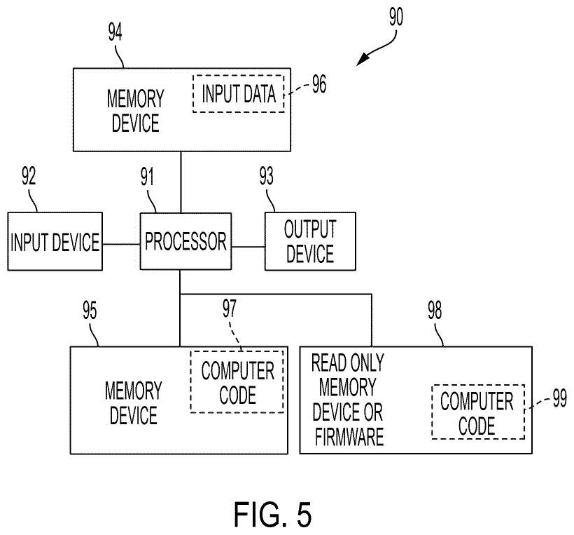

FIG. 5 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for assessing N machine learning (ML) models that predict a dependent variable, N being at least 1, said method comprising:
for n=1, . . . , N: training, by one or more processors of a computer system, a machine learning model n using training data n comprising Iₙ data points, wherein data point Pₙᵢ in the training data n includes an observed dependent variable yₙᵢ (i=1, . . . , Iₙ), wherein said training the machine learning model n comprises:
(i) tuning the machine learning model n to generate a predicted dependent variable f(xₙ)ₙᵢ that is fitted, using a regression algorithm n, to the observed dependent variable yₙᵢ (i=1, . . . , Iₙ),
(ii) determining a universal R-squared (UR²ₙ) for the predicted dependent variables f(xₙ)ₙᵢ (i=1, . . . , Iₙ), and
(iii) outputting f(xₙ)ₙᵢ (i=1, . . . , Iₙ) and UR²ₙ, wherein xₙ is a feature vector of one or more features used by machine learning model n to predict the dependent variable f(xₙ)ₙᵢ (i=1, . . . , Iₙ).

2. The method of claim 1, wherein said training the machine learning model n comprises determining UR²ₙ after the machine learning model n has been tuned.

3. The method of claim 1, wherein said tuning the machine learning model n comprises minimizing a loss function using backpropagation, subject to a constraint of maximizing UR²ₙ.

4. The method of claim 1, wherein the training data n includes at least one outlier in the observed dependent variables yₙᵢ (i=1, . . . Iₙ).

5. The method of claim 1, wherein the regression algorithm n is a non-linear regression algorithm.

6. The method of claim 1, wherein N is at least 2, and wherein the N machine learning models are selected from the group consisting of machine learning models having different regression algorithms, machine learning models having different features, machine learning models having different tuning parameters, and combinations thereof.

7. The method of claim 1, wherein N is at least 2, and wherein the method comprises:
selecting, by the one or more processors, a best machine language model as the machine learning model n1 having the maximum UR²ₙ₁, wherein n1 is 1, . . . or N.

8. The method of claim 1, wherein N is at least 2, and wherein the method comprises:
selecting, by the one or more processors, two top machine language models as the machine learning models n1 and n2 having the highest UR²ₙ₁ and UR²ₙ₂, wherein n1 and n2 are each 1, . . . or N; and
if |UR²ₙ₁−UR²ₙ₂| exceeds a specified UR²-difference threshold then selecting, by the one or more processors, a best machine language model as the machine learning model n1 or n2 having the highest UR², otherwise selecting the best machine language model as the machine learning model n1 or n2 having a fewest number of features in the feature vectors xₙ₁ and xₙ₂.

9. A computer program product, comprising one or more computer readable hardware storage devices having computer readable program code stored therein, said program code containing instructions executable by one or more processors of a computer system to implement a method for assessing N machine learning (ML) models that predict a dependent variable, N being at least 1, said method comprising:
for n=1, . . . , N: training, by the one or more processors, a machine learning model n using training data n comprising Iₙ data points, wherein data point Pₙᵢ in the training data n includes an observed dependent variable yₙᵢ (i=1, . . . , Iₙ), wherein said training the machine learning model n comprises:
(i) tuning the machine learning model n to generate a predicted dependent variable f(xₙ)ₙᵢ that is fitted, using a regression algorithm n, to the observed dependent variable yₙᵢ (i=1, . . . , Iₙ),
(ii) determining a universal R-squared (UR²ₙ) for the predicted dependent variables f(xₙ)ₙᵢ (i=1, . . . , Iₙ), and
(iii) outputting f(xₙ)ₙᵢ (i=1, . . . , Iₙ) and UR²ₙ, wherein xₙ is a feature vector of one or more features used by machine learning model n to predict the dependent variable f(xₙ)ₙᵢ (i=1, . . . , Iₙ).

10. The computer program product of claim 9, wherein said training the machine learning model n comprises determining UR²ₙ after the machine learning model n has been tuned.

11. The computer program product of claim 9, wherein said tuning the machine learning model n comprises minimizing a loss function using backpropagation, subject to a constraint of maximizing UR²ₙ.

12. The computer program product of claim 9, wherein the training data n includes at least one outlier in the observed dependent variables yₙᵢ (i=1, . . . Iₙ).

13. The computer program product of claim 9, wherein the regression algorithm n is a non-linear regression algorithm.

14. The computer program product of claim 9, wherein N is at least 2, and wherein the N machine learning models are selected from the group consisting of machine learning models having different regression algorithms, machine learning models having different features, machine learning models having different tuning parameters, and combinations thereof.

15. A computer system, comprising one or more processors, one or more memories, and one or more computer readable hardware storage devices, said one or more hardware storage devices containing program code executable by the one or more processors via the one or more memories to implement a method for assessing N machine learning (ML) models that predict a dependent variable, N being at least 1, said method comprising:
for n=1, . . . , N: training, by the one or more processors, a machine learning model n using training data n comprising Iₙ data points, wherein data point Pₙᵢ in the training data n includes an observed dependent variable yₙᵢ (i=1, . . . , Iₙ), wherein said training the machine learning model n comprises:
(i) tuning the machine learning model n to generate a predicted dependent variable f(xₙ)ₙᵢ that is fitted, using a regression algorithm n, to the observed dependent variable yₙᵢ (i=1, . . . , Iₙ),
(ii) determining a universal R-squared (UR²ₙ) for the predicted dependent variables f(xₙ)ₙᵢ (i=1, . . . , Iₙ), and
(iii) outputting f(xₙ)ₙᵢ (i=1, . . . , Iₙ) and UR²ₙ, wherein xₙ is a feature vector of one or more features used by machine learning model n to predict the dependent variable f(xₙ)ₙᵢ (i=1, . . . , Iₙ).

16. The computer system of claim 15, wherein said training the machine learning model n comprises determining UR²ₙ after the machine learning model n has been tuned.

17. The computer system of claim 15, wherein said tuning the machine learning model n comprises minimizing a loss function using backpropagation, subject to a constraint of maximizing UR²ₙ.

18. The computer system of claim 15, wherein the training data n includes at least one outlier in the observed dependent variables yₙᵢ (i=1, . . . Iₙ).

19. The computer system of claim 15, wherein the regression algorithm n is a non-linear regression algorithm.

20. The computer system of claim 15, wherein N is at least 2, and wherein the N machine learning models are selected from the group consisting of machine learning models having different regression algorithms, machine learning models having different features, machine learning models having different tuning parameters, and combinations thereof.
